(19) United States
(12) Patent Application Publication
(10) Pub. No.: US 2026/0267545 A1
(43) Pub. Date: Sep. 10, 2026

(54) STORAGE DEVICE, OPERATING METHOD OF THE SAME, AND OPERATING METHOD OF ELECTRONIC SYSTEM INCLUDING THE SAME

(71) Applicant: SK hynix Inc., Icheon-si (KR)

(72) Inventor: Jung Woo KIM, Icheon-si (KR)

(21) Appl. No.: 19/323,760

(22) Filed: Sep. 9, 2025

(30) Foreign Application Priority Data
Mar. 6, 2025 (KR) 10-2025-0028880

(51) Int. Cl. G06F 3/06

(52) U.S. Cl. CPC G06F 3/064; G06F 3/0616; G06F 3/0631; G06F 3/0679

(57) ABSTRACT

A storage device includes a memory device including a plurality of memory blocks, and a controller. The controller is configured to allocate one or more of the plurality of memory blocks to each of a plurality of zone regions, determine, as victim memory blocks, one or more memory blocks having remaining spaces, sizes of which each exceed a threshold size, among memory blocks allocated to closed zone regions among the plurality of zone regions, a remaining space representing an empty space in which no data is stored, and merge at least one or more of the victim memory blocks into a target memory block. The plurality of zone regions respectively correspond to logical address groups received from an external host device.

### CROSS-REFERENCE TO RELATED APPLICATION

The present application claims priority under 35 U.S.C. § 119(a) to Korean patent application number 10-2025-0028880, filed on Mar. 6, 2025, in the Korean Intellectual Property Office, the entire disclosure of which is incorporated herein by reference.

### BACKGROUND

### 1. Technical Field

Various embodiments of the present disclosure generally relate to a storage device, an operating method of the storage device, and an operating method of an electronic system including the storage device, and more particularly, to a storage device capable of merging memory blocks, an operating method of the storage device, and an operating method of an electronic system including the storage device.

### 2. Related Art

A memory device stores data in response to a write request, and outputs stored data in response to a read request. For example, a memory device is classified as a volatile memory device, such as Dynamic Random Access Memory (DRAM), Static RAM (SRAM), or the like, which loses stored data when supplied power is interrupted, or a non-volatile memory device, such as flash memory, Phase-change RAM (PRAM), Magnetic RAM (MRAM), Resistive RAM (RRAM), or the like, which retains stored data even when supplied power is interrupted.

Generally, a non-volatile memory device may store data using random (or arbitrary) access. As garbage collection (GC) is frequently performed over the entire area due to random access, the lifespan of the non-volatile memory device may be reduced. To avoid this, techniques may be utilized to distinguish memory blocks of a non-volatile memory device into zone regions, and to sequentially store related data within the zone regions. There may be a need for a method for efficiently managing storage spaces allocated to zone regions.

### SUMMARY

Various embodiments of the present disclosure are directed to a storage device capable of efficiently managing a memory space, an operating method of the storage device, and an operating method of an electronic system including the storage device.

According to an embodiment of the present disclosure, a storage device is provided. The storage device includes a memory device including a plurality of memory blocks, and a controller configured to allocate one or more of the plurality of memory blocks to each of a plurality of zone regions; determine, as victim memory blocks, one or more memory blocks having remaining spaces, sizes of which each exceed a threshold size, among memory blocks allocated to closed zone regions among the plurality of zone regions, a remaining space representing an empty space in which no data is stored; and merge at least one or more of the victim memory blocks into a target memory block, wherein the plurality of zone regions respectively correspond to logical address groups received from an external host device.

According to an embodiment of the present disclosure, a method of operating a storage device is provided. The method comprises allocating one or more of a plurality of memory blocks to each of a plurality of zone regions; determining, as victim memory blocks, one or more memory blocks having remaining spaces, sizes of which each exceed a threshold size, among memory blocks allocated to closed zone regions among the plurality of zone regions, a remaining space representing an empty space in which no data is stored; and merging at least one or more of the victim memory blocks into a target memory block, wherein the plurality of zone regions respectively correspond to logical address groups received from an external host device.

According to an embodiment of the present disclosure, method of operating an electronic system is provided. The method comprises allocating, by a storage device, one or more of a plurality of memory blocks to each of a plurality of zone regions; transmitting, by a host device, a zone close request to the storage device; closing, by the storage device, zone regions indicated by the zone close request among the plurality of zone regions; transmitting, by the storage device, a zone close response to the host device; determining, by the storage device, as victim memory blocks, one or more memory blocks having remaining spaces, sizes of which each exceed a threshold size among memory blocks allocated to closed zone regions among the plurality of zone regions, a remaining space representing an empty space in which no data is stored; and merging, by the storage device, at least one or more of the victim memory blocks into a target memory block, wherein the plurality of zone regions respectively correspond to logical address groups received from the host device.

### BRIEF DESCRIPTION OF THE DRAWINGS

FIG. 1 illustrates an electronic system according to an embodiment of the present disclosure.

FIG. 2 illustrates a memory block according to an embodiment of the present disclosure.

FIG. 3 illustrates a storage device according to an embodiment of the present disclosure.

FIG. 4 illustrates logical address groups according to an embodiment of the present disclosure.

FIG. 5A illustrates a merge operation of a storage device according to an embodiment of the present disclosure.

FIG. 5B illustrates a merge operation of a storage device according to another embodiment of the present disclosure.

FIG. 6 illustrates a mapping table according to an embodiment of the present disclosure.

FIG. 7 is a flowchart illustrating a method of operating a storage device according to an embodiment of the present disclosure.

FIG. 8 is a flowchart illustrating a method of operating a storage device according to an embodiment of the present disclosure.

FIG. 9 is a flowchart illustrating a method of operating a storage device according to an embodiment of the present disclosure.

FIG. 10 illustrates groups of victim memory blocks according to an embodiment of the present disclosure.

FIG. 11 illustrates a merge operation of a storage device according to an embodiment of the present disclosure.

FIG. 12 is a flowchart illustrating a method of operating an electronic system according to an embodiment of the present disclosure.

FIG. 13 illustrates an electronic system according to an embodiment of the present disclosure.

FIG. 14 illustrates an electronic system according to an embodiment of the present disclosure.

FIG. 15 illustrates an electronic system according to an embodiment of the present disclosure.

FIG. 16 illustrates a network system including an electronic system according to an embodiment of the present disclosure.

### DETAILED DESCRIPTION

Hereinafter, embodiments of the present disclosure are described in a clear and detailed manner to the extent that those skilled in the art can readily implement the embodiments of the present disclosure.

It will be understood that, although the terms “first,” “second,” or the like, may be used herein to describe various elements, these elements are not limited by these terms. These terms are used for distinguishing one element from another element and not to suggest a number or order of elements.

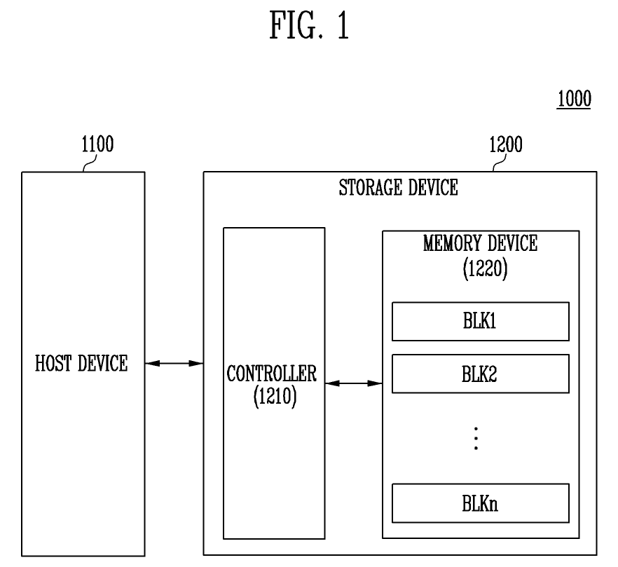

FIG. 1 illustrates an electronic system 1000 according to an embodiment of the present disclosure. Referring to FIG. 1, the electronic system 1000 may be a computing system configured to process various information or store the processed information as data. In some embodiments, the electronic system 1000 may be implemented as a personal computer (PC), a notebook, a laptop, a server, a workstation, a tablet PC, a smartphone, a digital camera, a black box, or the like.

The electronic system 1000 may include a host device 1100 and a storage device 1200. The host device 1100 may control various operations of the electronic system 1000. More particularly, the host device 1100 may control operations of other components constituting the electronic system 1000. The host device 1100 may be implemented as a general-purpose processor, a dedicated processor, an application processor (AP), or the like.

The host device 1100 may communicate with the storage device 1200. For example, the host device 1100 may request the storage device 1200 to perform operations such as a program operation, a read operation, an erase operation, and the like. For this purpose, the host device 1100 may transmit a host request, data, and a logical address to the storage device 1200 for performing a program operation. The host device 1100 may transmit a host request and a logical address to the storage device 1200 for performing a read operation.

The host device 1100 may support a Zoned Namespace (ZNS) standard. The ZNS standard may be a protocol which supports sequential writing within a zone region. In general, a non-volatile memory device may store data using random access. For example, data corresponding to sequential Logical Block Addresses (LBAs) may be stored in memory cells or memory blocks which are not physically sequential. As garbage collection (GC) is frequently performed over the entire area due to random access, the lifespan of the non-volatile memory device may be reduced. To prevent or mitigate this, memory blocks of the non-volatile memory device may be separated into zone regions, and data may be sequentially stored in the zone regions. Sequentially storing data may refer to sequentially storing data corresponding to sequential LBAs at physically adjacent Physical Block Addresses (PBAs).

The host device 1100 may determine a state of a zone region. The determined state of the zone region may include one of an empty state, an open state, a closed state, a full state, and the like. For example, the open state may indicate that both write and read operations are permitted in the zone region. The closed state may indicate that a write operation is prohibited in the zone region, while a read operation remains allowed. The host device 1100 may determine the state of the zone region and send a request corresponding to the determined state to the storage device 1200.

The storage device 1200 may store data. For example, data may be stored under the control of the host device 1100. In some embodiments, the storage device 1200 may include at least one of a solid state drive (SSD), embedded memory, or removable external memory. When the storage device 1200 is an SSD, the storage device 1200 may be a device conforming to a Non-Volatile Memory express (NVMe) standard. When the storage device 1200 is embedded memory or removable external memory, the storage device 1200 may be a device conforming to a Universal Flash Storage (UFS) or embedded Multi-Media Card (eMMC) standard. The host device 1100 and the storage device 1200 may each generate a packet based on an employed standard protocol and transmit the generated packet to each other.

The storage device 1200 may support a ZNS standard. For example, the storage device 1200 may allocate physical blocks (e.g., memory blocks BLK1 to BLKn in a memory device 1220) to a zone region in response to a request from the host device 1100. In the zone region, data associated with LBAs may be stored in the allocated physical blocks. The zone region may conceptually refer to the LBAs designated by the host device 1100 and the corresponding physical blocks in the storage device 1200.

The storage device 1200 may include a controller 1210 and the memory device 1220. The controller 1210 may control the operation of the storage device 1200. For example, the controller 1210 may control the operation of the storage device 1200 according to an internal policy or in response to a request from the host device 1100. The controller 1210 may store data in the memory device 1220 or read data stored in the memory device 1220 according to the internal policy or in response to the request from the host device 1100.

The controller 1210 may generate a program command and provide the generated program command to the memory device 1220 in response to a host request corresponding to a program operation received from the host device 1100. The controller 1210 may generate a read command and provide the generated read command to the memory device 1220 in response to a host request corresponding to a read operation received from the host device 1100. The controller 1210 may transmit data read from the memory device 1220 to the host device 1100.

The memory device 1220 may store data under the control of the controller 1210. The memory device 1220 may include the plurality of memory blocks BLK1 to BLKn. At least one or more of the plurality of memory blocks BLK1 to BLKn may be allocated to zone regions. n is a positive integer greater than 1.

The memory device 1220 may be NAND flash memory, but the scope of the present disclosure is not limited thereto. The memory device 1220 may be one of various storage devices which may retain stored data even when supplied power is interrupted, such as Phase-change Random Access Memory (PRAM), Magnetic Random Access Memory (MRAM), Resistive Random Access Memory (RRAM), or Ferroelectric Random Access Memory (FRAM).

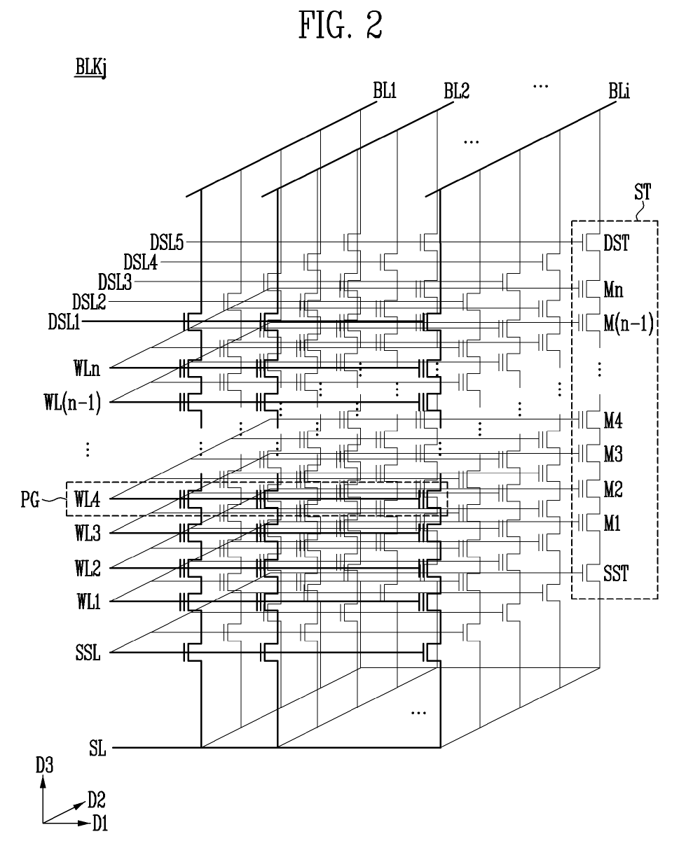

FIG. 2 illustrates a memory block according to an embodiment of the present disclosure. For example, FIG. 2 illustrates a j-th memory block BLKj among the plurality of memory blocks BLK1 to BLKn of FIG. 1. j is an arbitrary positive integer between 1 and n.

Since the plurality of memory blocks BLK1 to BLKn are similarly configured, the j-th memory block BLKj is shown as a representative example. The j-th memory block BLKj may include a plurality of strings ST connected between a source line SL and first to i-th bit lines BL1 to BLi, where i is a positive integer greater than 1. The plurality of strings ST may be connected in common to the source line SL. The plurality of strings ST may be arranged to be spaced apart from each other in a first direction D1 and a second direction D2, and may extend in a third direction D3. The first to i-th bit lines BL1 to BLi may be arranged to be spaced apart from each other in the first direction D1, and each of the first to i-th bit lines BL1 and BLi may extend in the second direction D2. Multiple strings ST arranged in the second direction D2 may be connected in common to each of the first to i-th bit lines BL1 to Bli. Multiple strings ST arranged in the first direction D1 may be respectively connected to the first to i-th bit lines BL1 and BLi.

The numbers of source select transistors SST, first to n-th memory cells M1 to Mn, and drain select transistors DST included in each of the strings ST may vary depending on the design of a memory device. For example, although FIG. 2 illustrates each of the strings ST as including one source select transistor SST and one drain select transistor DST, a plurality of source select transistors SST and/or a plurality of drain select transistors DST may be provided in some implementations.

Gates of source select transistors SST included in the different strings ST may be connected to source select lines SSL. Gates of the first to n-th memory cells M1 to Mn in the string ST may be connected to first to n-th word lines WL1 to WLn, respectively. Gates of drain select transistors DST coupled to one bit line may be connected to, e.g., first to fifth drain select lines DSL1 to DSL5 when five strings ST are connected to the one bit line. n is a positive integer. The first to fifth drain select lines DSL1 to DSL5 are provided as an example, and the scope of the present disclosure is not limited thereto.

The source select lines SSL may be connected in common to the source select transistors SST arranged in the first direction D1 and the second direction D2, but one or more of the source select lines SSL arranged in the second direction D2 may be spaced apart from each other. Each of the first to n-th word lines WL1 to WLn may be connected in common to memory cells arranged in the first direction D1 and the second direction D2 at the same level in the third direction D3. For example, the n-th memory cells Mn arranged in the first direction D1 and the second direction D2 may be connected in common to the n-th word lines WLn, and the n-th word lines WLn may be connected to each other. For example, the (n-1)-th memory cells M(n-1) arranged in the first direction D1 and the second direction D2 may be connected in common to the (n-1)-th word lines WL(n-1), and the (n-1)-th word lines WL(n-1) may be connected to each other. The n-th word line WLn and the (n-1)-th word line WL(n-1) are spaced apart from each other in the third direction D3.

A group of memory cells that are commonly connected to one of the first to n-th word lines WL1 to WLn may constitute a page PG. For example, the fourth memory cells M4 that are commonly connected to the fourth word line WL4 may constitute one page PG. A program operation may be performed in units of pages PG. When the fourth word line WL4 is a selected word line, the remaining word lines may be unselected word lines. The j-th memory block BLKj may include as many pages PG as the number of the first to n-th word lines WL1 to WLn.

In some embodiments, one memory cell may store one bit of data. A memory cell which can store one bit of data is generally referred to as a Single-Level Cell (SLC). In this case, one page PG may store one logical page (LPG) data. One LPG data may include as many data bits as the number of memory cells included in one page PG.

In some embodiments, one memory cell may store two or more bits of data. A memory cell which can store two or more bits of data is generally referred to as a Multi-Level Cell (MLC). In this case, one physical page PG may store two or more LPG data.

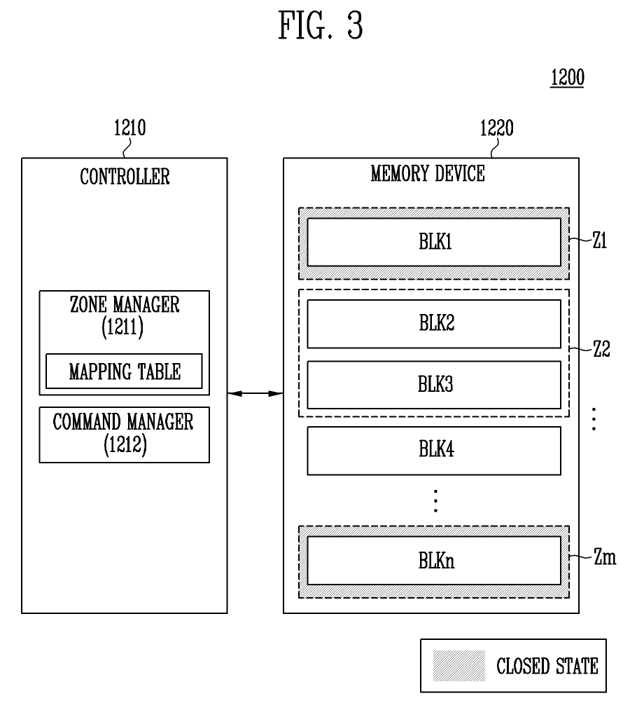

FIG. 3 illustrates a storage device 1200 according to an embodiment of the present disclosure. Referring to FIG. 3, the storage device 1200 may include a controller 1210 and a memory device 1220. The controller 1210 and the memory device 1220 illustrated in FIG. 3 may respectively correspond to the controller 1210 and the memory device 1220 illustrated in FIG. 1.

The controller 1210 may allocate the plurality of memory blocks BLK1 to BLKn of the memory device 1220 to a plurality of zone regions Z1 to Zm. For example, the storage device 1200 may allocate one or more of the plurality of memory blocks BLK1 to BLKn to each of the plurality of zone regions Z1 to Zm according to an internal policy or in response to a request from the host device 1100 of FIG. 1. The plurality of zone regions Z1 to Zm may respectively correspond to a plurality of logical address groups received from the host device 1100 of FIG. 1. n and m are arbitrary positive integers.

In some embodiments, the controller 1210 may allocate one or more memory blocks to one zone region according to an internal policy or in response to a request from the host device 1100 of FIG. 1. For example, the controller 1210 may allocate the first memory block BLK1 to the first zone region Z1, the second and third memory blocks BLK2 and BLK3 to the second zone region Z2, and the n-th memory block BLKn to the m-th zone region Zm. One or more of the plurality of memory blocks BLK1 to BLKn (e.g., the fourth memory block BLK4) may remain unallocated to any zone region.

The controller 1210 may read data stored in the plurality of memory blocks BLK1 to BLKn or store data in the plurality of memory blocks BLK1 to BLKn. For example, the controller 1210 may receive logical address groups, commands, and data corresponding to the plurality of zone regions Z1 to Zm from the host device 1100 of FIG. 1, and store the data in the plurality of memory blocks BLK1 to BLKn allocated to the plurality of zone regions Z1 to Zm, or read data stored in the plurality of memory blocks BLK1 to BLKn, and transmit the read data to the host device 1100.

The controller 1210 may receive a request corresponding to states of the plurality of zone regions Z1 to Zm from the host device 1100 of FIG. 1. For example, the host device 1100 of FIG. 1 may determine a state of a zone region and provide a request corresponding to the determined state to the controller 1210. The state of the zone region may include an empty state, an open state, a closed state, a full state, or the like.

In some embodiments, the controller 1210 may be permitted to read data from a memory block corresponding to a closed zone region, but may be restricted from storing additional data in that memory block. For example, the controller 1210 may read data from the first and n-th memory blocks BLK1 and BLKn corresponding to the closed first and m-th zone regions Z1 and Zm, but may be restricted from storing additional data in the first and n-th memory blocks BLK1 and BLKn.

The host device 1100 of FIG. 1 may determine the state of the zone region based on various factors. In some embodiments, the host device 1100 may determine that one or more zone regions are in a closed state when it is necessary to protect the integrity of data stored in the one or more zone regions or when there is no further need to store additional data. One or more of the closed zone regions may not be in a full state. In other words, memory blocks corresponding to the one or more of the closed zone regions may still have remaining spaces capable of storing additional data. As the amount of unused spaces in the memory blocks corresponding to the closed zone regions increases, the overall space efficiency of the memory device 1220 decreases.

The controller 1210 may merge memory blocks allocated to the closed zone regions into a target memory block. For example, the controller 1210 may determine memory blocks allocated to the closed zone regions as victim memory blocks, and merge at least one or more of the victim memory blocks into the target memory block. During this process, the controller 1210 may copy valid data from the victim memory blocks to the target memory block.

In some embodiments, the memory blocks determined as the victim memory blocks may store valid data. For example, the victim memory blocks may store user data received from the host device 1100 of FIG. 1 as the valid data, and the zone regions to which the victim memory blocks are allocated may be in a closed state. For example, the victim memory blocks may store only the valid data. The controller 1210 may copy the valid data from the victim memory blocks to the target memory block, so that the target memory block may store the valid data from the victim memory blocks (e.g., all valid data or user data included in the zone regions to which the victim memory blocks are allocated).

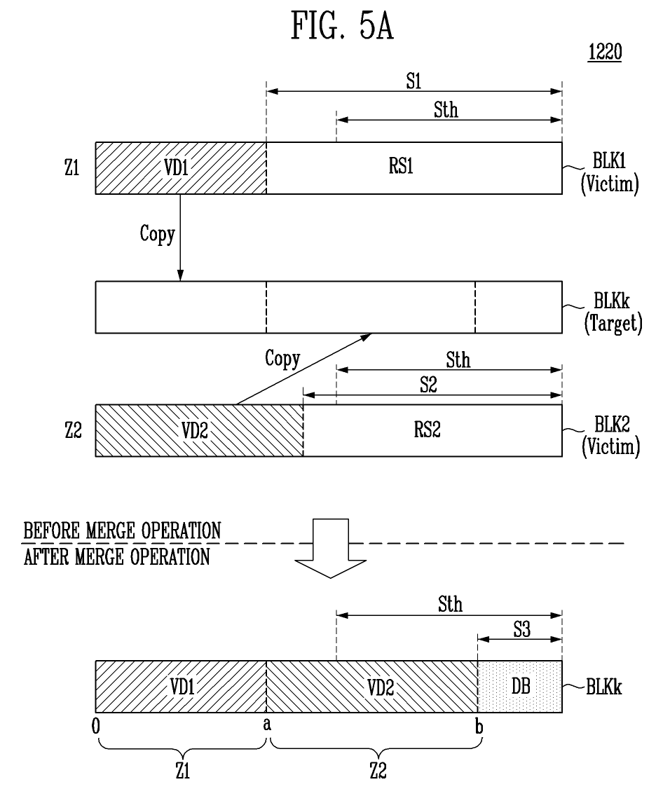

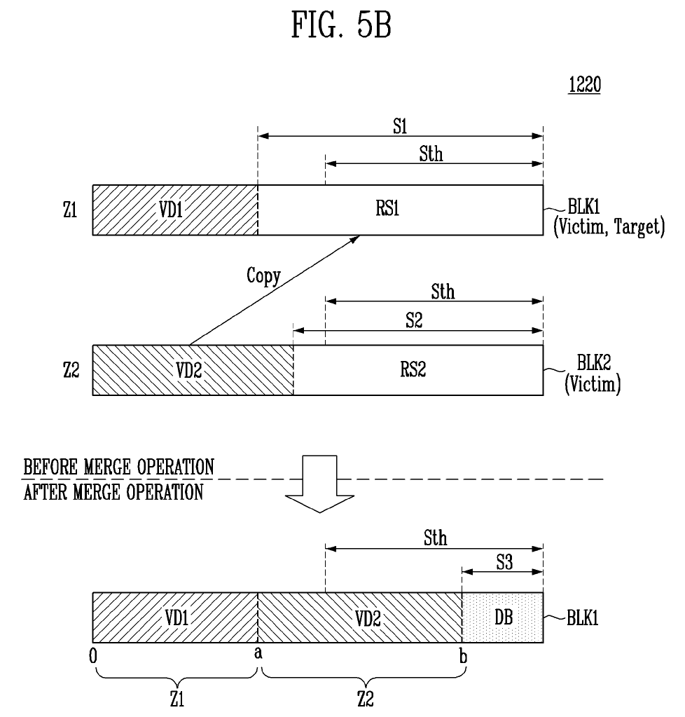

In some embodiments, the controller 1210 may determine, as the victim memory blocks, one or more of the memory blocks allocated to the closed zone regions, the one or more memory blocks each having a remaining space exceeding a threshold size. For example, the controller 1210 may determine sizes of remaining spaces in the first and n-th memory blocks BLK1 and BLKn corresponding to the first and m-th zone regions Z1 and Zm which are in a closed state, and determine memory blocks, each having a remaining space exceeding the threshold size, as the victim memory blocks. When each of the sizes of the remaining spaces in the first and n-th memory blocks BLK1 and BLKn exceeds the threshold size, the controller 1210 may determine the first and n-th memory blocks BLK1 and BLKn as the victim memory blocks. The controller 1210 may merge the first and n-th memory blocks BLK1 and BLKn into the target memory block. A more detailed description of the target memory block will be provided below with reference to FIGS. 5A and 5B.

In some embodiments, the controller 1210 may merge the victim memory blocks into the target memory block in response to determining that the number of victim memory blocks exceeds a reference value. For example, the controller 1210 may determine the number of victim memory blocks and, in response to determining that the number of victim memory blocks exceeds the reference value, merge at least one or more of the victim memory blocks into the target memory block.

The controller 1210 may include a zone manger 1211 and a command manager 1212. The zone manager 1211 and the command manager 1212 may perform operations of the controller 1210 described above.

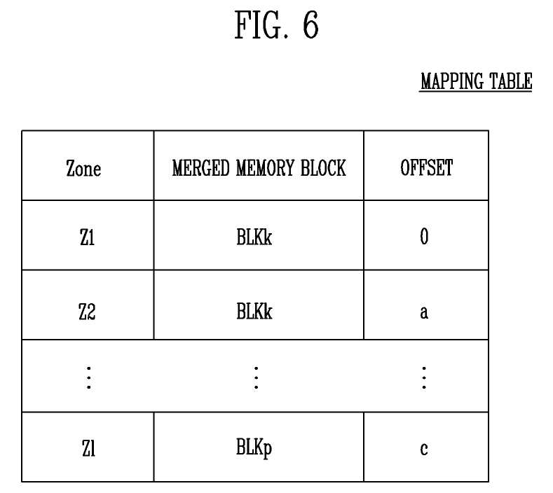

In some embodiments, the controller 1210 may include a mapping table. The controller 1210 may store, in the mapping table, information about the merged victim memory blocks, zone regions corresponding to the merged victim memory blocks, and offsets. For example, after merging the victim memory blocks into the target memory block, the controller 1210 may update the mapping table with information about the zone regions corresponding to the merged victim memory blocks and the offsets. A more detailed description of the mapping table will be provided below with reference to FIG. 6.

The memory device 1220 may include the plurality of memory blocks BLK1 to BLKn. At least one or more of the plurality of memory blocks BLK1 to BLKn may be allocated to each of the plurality of zone regions Z1 to Zm. For example, the first memory block BLK1 may be allocated to the first zone region Z1, the second and third memory blocks BLK2 and BLK3 may be allocated to the second zone region Z2, and the n-th memory block BLKn may be allocated to the m-th zone region Zm. The fourth memory block BLK4 may remain unallocated to any zone region.

The memory blocks (e.g., the first to third memory blocks BLK1 to BLK3 and the n-th memory block BLKn) allocated to the plurality of zone regions Z1 to Zm may be physical storage spaces in which data corresponding to the plurality of zone regions Z1 and Zm is stored. No additional data may be written to the memory blocks (e.g., the first and n-th memory blocks BLK1 and BLKn) allocated to the closed zone regions (e.g., the first and m-th zone regions Z1 and Zm) among the plurality of zone regions Z1 to Zm.

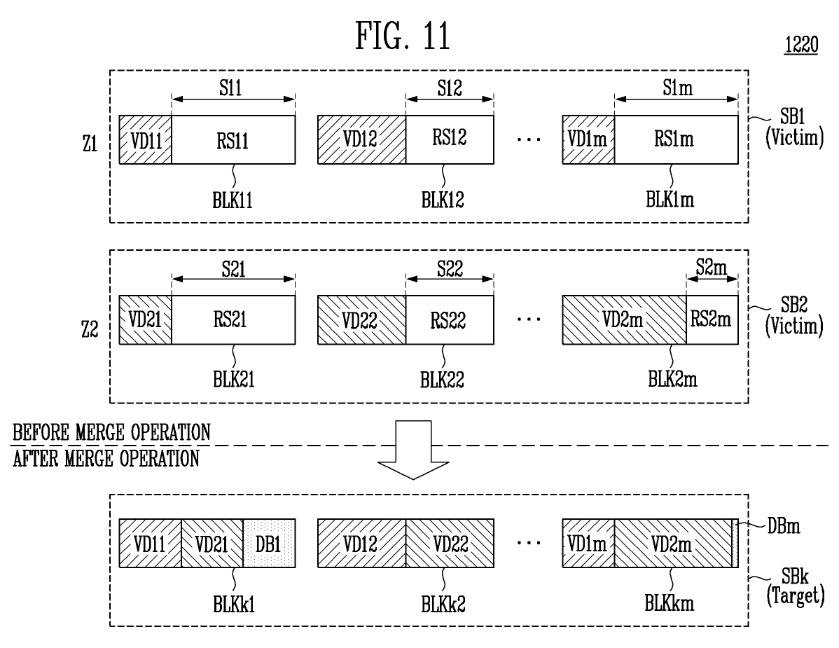

Although the plurality of memory blocks BLK1 to BLKn are illustrated, the scope of the present disclosure is not limited thereto. The plurality of memory blocks BLK1 to BLKn may be super memory blocks each including a plurality of memory blocks, or may be storage spaces of various units. A more detailed description of the super memory blocks will be provided below with reference to FIG. 11.

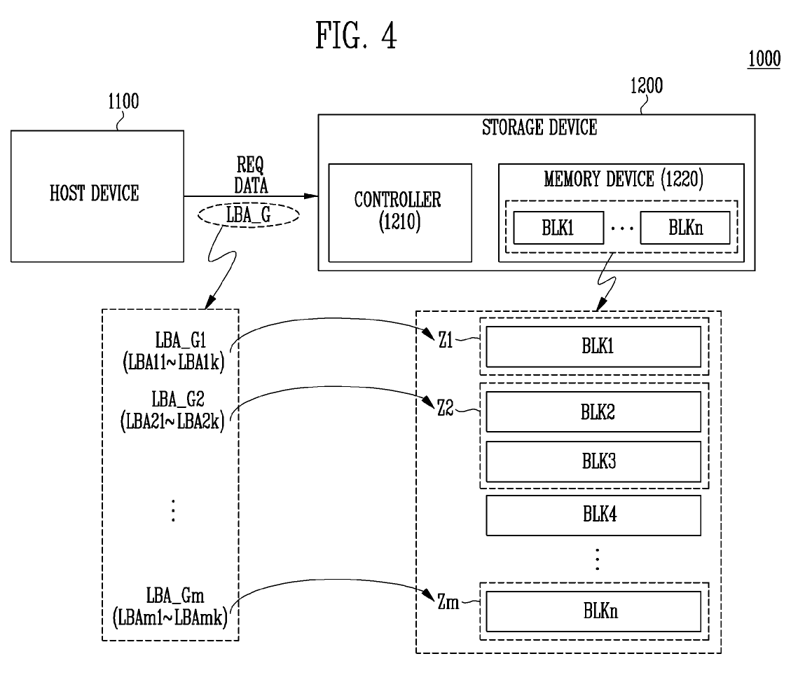

FIG. 4 illustrates logical address groups according to an embodiment of the present disclosure. The logical address groups will be described below with reference to the electronic system 1000 of FIG. 1.

Referring to FIG. 4, the host device 1100 may transmit logical address groups LBA_G, requests REQ, and data DATA to the storage device 1200. The logical address groups LBA_G may correspond to the plurality of zone regions Z1 to Zm, respectively. For example, when the logical address groups LBA_G include first to m-th logical address groups LBA_G1 to LBA_Gm, the first to m-th logical address groups LBA_G1 to LBA_Gm may correspond to the first to m-th zone regions Z1 to Zm, respectively. Each of the first to m-th logical address groups LBA_G1 to LBA_Gm may include k logical addresses, k being a positive integer greater than 1. For example, the first address group LBA_G1 includes first to k-th logical addresses LBA11 to LBA1k, the second address group LBA_G2 includes first to k-th logical addresses LBA21 to LBA2k, and the m-th address group LBA_Gm includes first to k-th logical addresses LBAm1 to LBAmk.

One or more of the plurality of memory blocks BLK1 to BLKn may be allocated to each of the first to m-th zone regions Z1 to Zm. For example, the first memory block BLK1 may be allocated to the first zone region Z1, the second and third memory blocks BLK2 and BLK3 may be allocated to the second zone region Z2, and the n-th memory block BLKn may be allocated to the m-th zone region Zm. In other words, at least one memory block may be allocated to each of the first to m-th zone regions Z1 to Zm.

The storage device 1200 may operate based on the logical address groups LBA_G, the data DATA, and the requests REQ received from the host device 1100. For example, the storage device 1200 may write the data DATA to a memory block allocated to a zone region corresponding to the logical address groups LBA_G based on a write request REQ. The storage device 1200 may identify memory blocks that correspond to zone regions and physical spaces indicated by the logical address groups LBA_G, based on metadata or the mapping table, and may perform operations on the identified memory blocks based on the requests REQ and the data DATA.

Although the logical address groups LBA_G respectively corresponding to the plurality of zone regions Z1 to Zm have been described as an example to facilitate understanding of the present disclosure, the scope of the present disclosure is not limited thereto. For example, the plurality of zone regions Z1 to Zm may correspond to a plurality of logical addresses.

In some embodiments, the storage device 1200 may operate based on logical addresses indicating the plurality of zone regions Z1 to Zm, the data DATA, and the requests REQ received from the host device 1100. For example, the storage device 1200 may write data to a memory block allocated to a zone region corresponding to logical addresses based on a write request. The storage device 1200 may identify memory blocks that correspond to zone regions and physical spaces indicated by the logical addresses, based on metadata or the mapping table, and may perform operations on the identified memory blocks based on the requests REQ and the data DATA.

FIG. 5A illustrates a merge operation of the storage device 1200 of FIG. 3 according to some embodiments of the present disclosure. Referring to FIG. 5A, the memory device 1220 may include the first, second, and k-th memory blocks BLK1, BLK2, and BLKk. k is an arbitrary positive integer between 1 and n.

For example, the first and second memory blocks BLK1 and BLK2 may be allocated to the first and second zone regions Z1 and Z2, which are closed zone regions, and may store data of the first and second zone regions Z1 and Z2. The first memory block BLK1 may store first valid data VD1 and have a first remaining space RS1 of a first size S1. In response to determining that the first size S1 exceeds a threshold size Sth, the controller 1210 of FIG. 3 may determine the first memory block BLK1 as a victim memory block. Similarly, in response to determining that a second size S2 of a second remaining space RS2 in the second memory block BLK2 exceeds the threshold size Sth, the controller 1210 of FIG. 3 may determine the second memory block BLK2 as a victim memory block. Herein, the remaining space denotes an unused area that is capable of storing data.

In some embodiments, the controller 1210 of FIG. 3 may determine the k-th memory block BLKk as a target memory block. The k-th memory block BLKk may be a memory block that is either empty (i.e., does not store valid data) or not allocated to any zone region among the plurality of memory blocks BLK1 to BLKn illustrated in FIG. 3.

The controller 1210 of FIG. 3 may merge the first and second memory blocks BLK1 and BLK2 into the k-th memory block BLKk determined as the target memory block. For example, the controller 1210 may copy or move the first valid data VD1 from the first memory block BLK1 and the second valid data VD2 from the second memory block BLK2 to the k-th memory block BLKk. In some embodiments, the controller 1210 may sequentially or randomly copy or move the first valid data VD1 and the second valid data VD2 to the k-th memory block BLKk.

In some embodiments, the controller 1210 may update information about the first and second memory blocks BLK1 and BLK2, the first and second zone regions Z1 and Z2, and offsets in the mapping table of FIG. 3 after copying the first and second valid data VD1 and VD2 to the k-th memory block BLKk. The offsets may refer to storage spaces in which the first valid data VD1 and the second valid data VD2 are respectively stored in the k-th memory block BLKk.

By moving the valid data VD1 and VD2 from the first and second memory blocks BLK1 and BLK2, which have the remaining spaces RS1 and RS2 of the sizes S1 and S2 greater than the threshold size Sth, to the target memory block, the space efficiency of the memory device 1220 may be improved.

In some embodiments, the controller 1210 of FIG. 3 may determine a third size S3 of a remaining space in the merged k-th memory block BLKk. In response to determining that the third size S3 is greater than 0, the controller 1210 may write dummy bits DB into the remaining space of the k-th memory block BLKk. By storing the dummy bits DB in the remaining space of the k-th memory block BLKk, the controller 1210 may enhance the consistency of the k-th memory block BLKk.

FIG. 5B illustrates a merge operation of the storage device 1200 of FIG. 3 according to another embodiment of the present disclosure. Referring to FIG. 5B, the memory device 1220 may include the first and second memory blocks BLK1 and BLK2.

For example, the first and second memory blocks BLK1 and BLK2 may be allocated to the first and second zone regions Z1 and Z2, which are closed zone regions, and may store data of the first and second zone regions Z1 and Z2. The first memory block BLK1 may store the first valid data VD1 and have the first remaining space RS1 of the first size S1. In response to determining that the first size S1 exceeds the threshold size Sth, the controller 1210 of FIG. 3 may determine the first memory block BLK1 as a victim memory block. Similarly, in response to determining that the second size S2 of the second remaining space RS2 in the second memory block BLK2 exceeds the threshold size Sth, the controller 1210 of FIG. 3 may determine the second memory block BLK2 as a victim memory block.

In some embodiments, the controller 1210 of FIG. 3 may determine at least one of the victim memory blocks as a target memory block. For example, the controller 1210 may determine the first memory block BLK1, which is one of the victim memory blocks, as the target memory block. For example, the controller 1210 may determine, as the target memory block, a memory block (e.g., the first memory block BLK1) having the largest remaining space among the victim memory blocks (e.g., the first and second memory blocks BLK1 and BLK2).

The controller 1210 of FIG. 3 may merge the first and second memory blocks BLK1 and BLK2 into the first memory block BLK1, which has been determined as the target memory block. For example, the controller 1210 may copy or move the second valid data VD2 from the second memory block BLK2 to the remaining space of the first memory block BLK1.

In some embodiments, the controller 1210 may update information about the first and second memory blocks BLK1 and BLK2, the first and second zone regions Z1 and Z2, and offsets in the mapping table of FIG. 3 after copying the second valid data VD2 to the remaining space of the first memory block BLK1. The offsets may refer to storage spaces in which the first valid data VD1 and the second valid data VD2 are respectively stored in the first memory block BLK1.

In some embodiments, the controller 1210 of FIG. 3 may determine a third size S3 of the remaining space in the merged first memory block BLK1. In response to determining that the third size S3 is greater than 0, the controller 1210 may write dummy bits DB into the remaining space of the merged first memory block BLK1.

FIG. 6 illustrates a mapping table according to an embodiment of the present disclosure. Referring to FIG. 6, the mapping table may include information about target memory blocks (or merged memory blocks), zone regions corresponding to victim memory blocks merged to the target memory blocks, and offsets in the target memory blocks. For example, the mapping table may include information about a memory block in which valid data corresponding to each zone region is stored, as well as offsets in the memory block.

For example, as illustrated in FIG. 5A, when the first and second memory blocks BLK1 and BLK2 corresponding to the first and second zone regions Z1 and Z2 are determined as victim memory blocks and merged into the k-th memory block (i.e., the target memory block), the mapping table may indicate that valid data corresponding to the first and second zone regions Z1 and Z2 are stored in the k-th memory block BLKk, with offsets of 0 and a.

The controller 1210 of FIG. 3 may merge the victim memory blocks into the target memory block and then update the mapping table, thereby managing the merged memory block which stores the valid data of the closed zone regions.

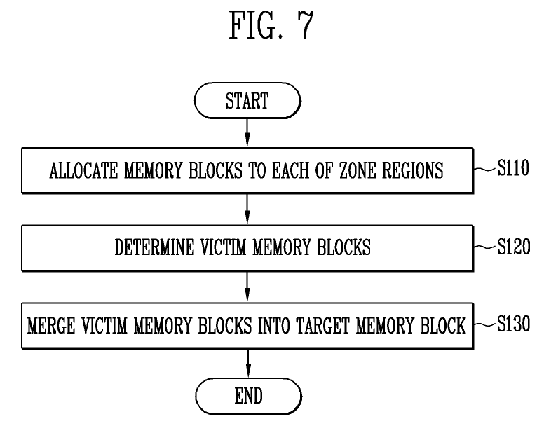

FIG. 7 is a flowchart illustrating a method of operating a storage device according to an embodiment of the present disclosure. Referring to FIG. 7, the storage device 1200 of FIG. 3 may merge victim memory blocks into a target memory block.

In step S110, the storage device 1200 may allocate a plurality of memory blocks to a plurality of zone regions. The plurality of zone regions may correspond to logical address groups received from the host device 1100 of FIG. 4, respectively. The number of the plurality of zone regions may be smaller than the number of the plurality of memory blocks. The storage device 1200 may allocate one or more of the plurality of memory blocks to each of the plurality of zone regions, and one zone region may include at least one memory block.

In some embodiments, the plurality of memory blocks may be super memory blocks each including a plurality of memory blocks, or may be storage spaces of various units. A more detailed description of the super memory blocks will be provided below with reference to FIG. 11.

In step S120, the storage device 1200 may determine victim memory blocks. The victim memory blocks may refer to memory blocks to be merged into the target memory block. For example, the storage device 1200 may determine the victim memory blocks among memory blocks allocated to closed zone regions.

In step S130, the storage device 1200 may merge the victim memory blocks into the target memory block. For example, the storage device 1200 may merge the victim memory blocks into the target memory block by copying or moving valid data from the victim memory blocks to the target memory block. In some embodiments, the storage device 1200 may copy or move the valid data from the victim memory blocks sequentially or randomly to a remaining space of the target memory block. The remaining space denotes an unused area that is capable of storing data.

In some embodiments, the storage device 1200 may determine an empty memory block or a memory block not allocated to any zone region among the plurality of memory blocks as the target memory block, or may determine one or more of the victim memory blocks as the target memory block.

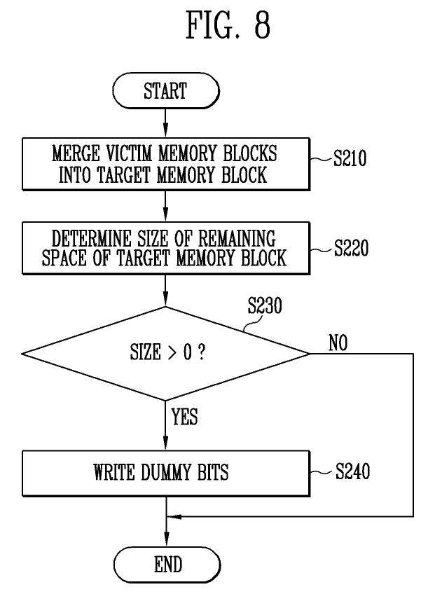

FIG. 8 is a flowchart illustrating a method of operating a storage device according to an embodiment of the present disclosure. Referring to FIG. 8, the storage device 1200 of FIG. 3 may write dummy bits into a remaining space of a target memory block.

In step S210, the storage device 1200 may merge victim memory blocks into the target memory block. For example, the storage device 1200 may merge the victim memory blocks into the target memory block by copying or moving valid data from the victim memory blocks to the remaining space of the target memory block. Step S210 may be partially similar to step S130 of FIG. 7.

In step S220, the storage device 1200 may determine a size of the remaining space in the target memory block after the merge operation. For example, the storage device 1200 may determine the size of the remaining space in the target memory block after copying or moving the valid data from the victim memory blocks to the remaining space of the target memory block.

In step S230, the storage device 1200 may determine whether the size of the remaining space in the target memory block after the merge operation exceeds 0. Based on this determination, the storage device 1200 may further determine whether the valid data from the victim memory blocks can fit into the remaining space of the target memory block.

For example, in response to determining that the size of the remaining space is 0, the storage device 1200 may determine that the valid data from the victim memory blocks fits into the remaining space of the target memory block. Alternatively, in response to determining that the size of the remaining space exceeds 0, the storage device 1200 may determine that the valid data from the victim memory blocks does not fit into the remaining space of the target memory block. In other words, after merging the victim memory blocks into the target memory block, the storage device 1200 may determine whether there is a remaining space in the target memory block.

In step S240, the storage device 1200 may write the dummy bits into the remaining space of the target memory block after the merge operation. For example, in response to determining that the remaining space of the target memory block exceeds 0, the storage device 1200 may write the dummy bits into the remaining space. As the dummy bits are written, the remaining space may be reduced or exhausted.

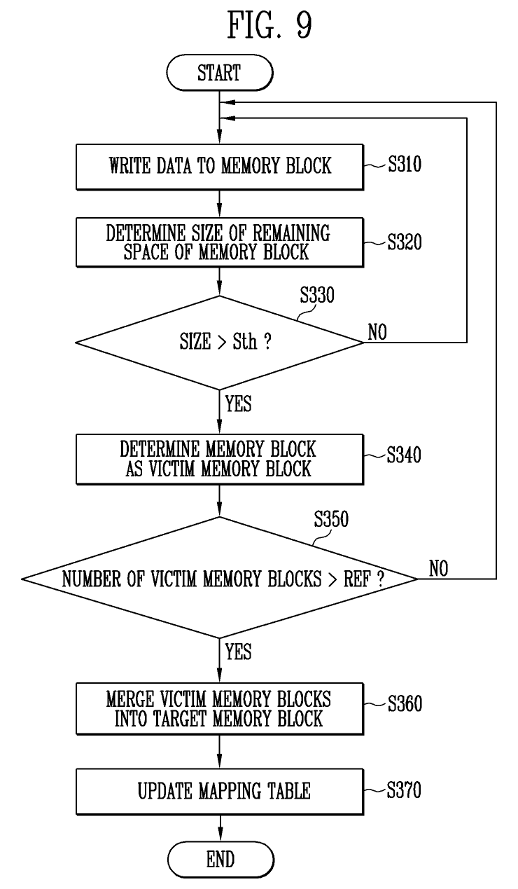

FIG. 9 is a flowchart illustrating a method of operating a storage device according to an embodiment of the present disclosure. Referring to FIG. 9, the storage device 1200 of FIG. 3 may update a mapping table after merging victim memory blocks into a target memory block.

In step S310, the storage device 1200 may write data into a memory block. For example, the storage device 1200 may receive data (e.g., user data), a write request, and a logical address group from the host device 1100 of FIG. 1, and may write the data into memory blocks allocated to zone regions corresponding to the logical address group (e.g., logical addresses), based on the write request.

In step S320, the storage device 1200 may determine a size of a remaining space in the memory block. For example, the storage device 1200 may select one of memory blocks allocated to each of the zone regions, and determine a size of a remaining space in the selected memory block.

In some embodiments, the storage device 1200 may further write (e.g., store) data into one or more memory blocks (e.g., first and second memory blocks) allocated to each of the zone regions in step S310, and then determine a size of a remaining space in one of the memory blocks (e.g., the first memory block). The storage device 1200 may determine a size of a remaining space in another memory block (e.g., the second memory block) either simultaneously with or after determining the size of the remaining space in the first memory block.

In step S330, the storage device 1200 may determine whether the size of the remaining space in the memory block exceeds a threshold size Sth. In response to determining that the size of the remaining space does not exceed the threshold size Sth, the storage device 1200 may repeat steps S310 to S330.

For example, the storage device 1200 may determine whether the size of the remaining space in the first memory block among a plurality of memory blocks exceeds the threshold size Sth. In response to determining that the size of the remaining space in the first memory block does not exceed the threshold size Sth, the storage device 1200 may repeat steps S310 to S330 to determine the size of the remaining space in the second memory block (or any memory block).

In step S340, in response to determining that the size of the remaining space in the memory block exceeds the threshold size Sth, the storage device 1200 may determine the memory block as a victim memory block. For example, in response to determining that the size of the remaining space in the first memory block among the plurality of memory blocks exceeds the threshold size Sth, the storage device 1200 may determine the first memory block as a victim memory block.

In step S350, the storage device 1200 may determine whether the number of victim memory blocks exceeds a reference value REF. In response to determining that the number of victim memory blocks does not exceed the reference value REF, the storage device 1200 may repeat steps S310 to S340.

For example, after determining the first memory block among the plurality of memory blocks as the victim memory block in step S340, in response to determining that the number of victim memory blocks does not exceed the reference value REF, the storage device 1200 may further perform operations of determining other memory blocks among the plurality of memory blocks as victim memory blocks by repeating steps S310 to S340.

In step S360, in response to determining that the number of victim memory blocks exceeds the reference value REF, the storage device 1200 may merge the victim memory blocks into the target memory block. The merge operation is performed under this condition to ensure that a size of the remaining space in the target memory block after the merge operation does not exceed the threshold size Sth. Furthermore, the storage device 1200 does not allow an unnecessary merge operation before the number of victim memory blocks exceeds the reference value REF, thereby reducing overhead and improving performance of the electronic system 1000 of FIG. 1.

In step S370, the storage device 1200 may update the mapping table. For example, the storage device 1200 may update the mapping table with information about the target memory block (or merged memory block), zone regions corresponding to the victim memory blocks, and offsets after merging the victim memory blocks into the target memory block. The mapping table may include information about a memory block in which valid data corresponding to each zone region is stored and offsets in the memory block.

The storage device 1200 may merge the victim memory blocks into the target memory block and then update the mapping table, thereby managing the merged memory blocks which store valid data of closed zone regions.

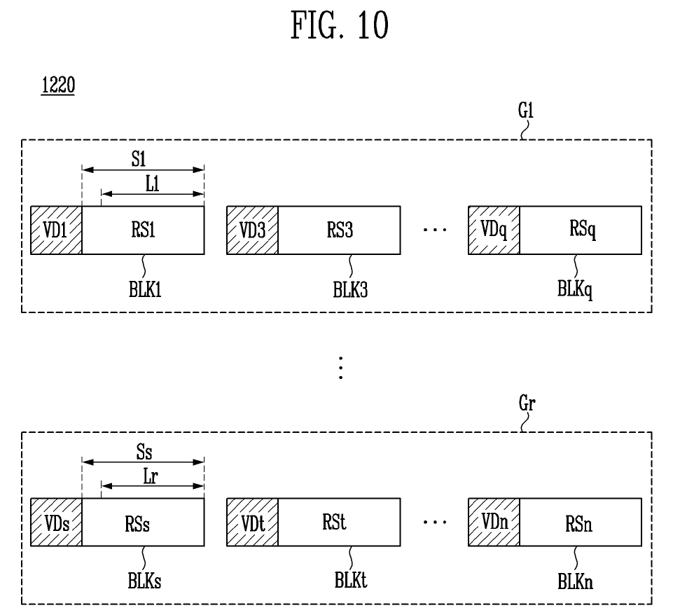

FIG. 10 illustrates groups of victim memory blocks according to an embodiment of the present disclosure. Referring to FIG. 10, the memory device 1220 of FIG. 3 may include the plurality of memory blocks BLK1 to BLKn classified into a plurality of groups G1 to Gr, r being a positive integer greater than 1. More specifically, the memory device 1220 may include victim memory blocks classified into the plurality of groups G1 to Gr, as well as remaining memory blocks that have not been determined as victim memory blocks (not shown).

As described above, the controller 1210 of FIG. 3 may determine, among the memory blocks allocated to the zone regions, one or more memory blocks whose remaining spaces respectively exceed a threshold size as victim memory blocks. The victim memory blocks may have remaining spaces of various sizes.

In some embodiments, the controller 1210 of FIG. 3 may classify the plurality of memory blocks BLK1 to BLKn or the memory blocks determined as victim memory blocks into the plurality of groups G1 to Gr. For example, the controller 1210 of FIG. 3 may classify the memory blocks, which are determined as the victim memory blocks, into the plurality of groups G1 to Gr based on a result of comparing sizes of remaining spaces RS1 to RSn of respective ones of the plurality of memory blocks BLK1 to BLKn with a plurality of reference sizes L1 to Lr.

The plurality of reference sizes L1 to Lr may have sequentially decreasing values. For example, the first reference size L1 may be the largest positive integer among the plurality of reference sizes L1 to Lr, and the r-th reference size Lr may be the smallest positive integer among the plurality of reference sizes L1 to Lr. r is a positive integer greater than 1 and less than n.

For example, the controller 1210 of FIG. 3 may classify memory blocks having remaining spaces with sizes between the r-th reference size Lr and the (r-1)-th reference size (not shown) into the r-th group Gr. The controller 1210 of FIG. 3 may classify memory blocks having a remaining space larger than the first reference size L1 into the first group G1. Thus, the memory device 1220 may include, for example, the first memory block BLK1, the third memory block BLK3, a q-th memory block BLKq, and the like, classified into the first group G1 (i.e., having a remaining space greater than the first reference size L1). The memory device 1220 may also include, for example, an s-th memory block BLKs, a t-th memory block BLKt, an n-th memory block BLKn, and the like, classified into the r-th group Gr (i.e., having a remaining space between the r-th reference size Lr and the (r-1)-th reference size (not shown)). Although not shown in FIG. 10, the memory device 1220 may include memory blocks classified into different groups based on operations of comparing sizes of remaining spaces with the reference sizes L1 to Lr.

For example, the memory blocks classified into the first group G1 (e.g., the first memory block BLK1, the third memory block BLK3, the q-th memory block BLKq, and the like) may have remaining spaces each having a size larger than the first reference size L1, which is the largest reference size. That is, the memory blocks classified into the first group G1 may have remaining spaces of the largest size among a plurality of memory blocks in the memory device 1220. Similarly, the memory blocks classified into the second group (not shown) may have remaining spaces of the second largest size (smaller than the remaining spaces of the memory blocks classified into the first group G1). Finally, the memory blocks classified into the r-th group Gr may have remaining spaces of the smallest size.

In some embodiments, the controller 1210 of FIG. 3 may merge memory blocks from one or more groups among the plurality of memory blocks BLK1 to BLKn classified into the plurality of groups G1 to Gr into a target memory block. For example, the controller 1210 of FIG. 3 may merge the memory blocks of the first group G1 (e.g., the first memory block BLK1, the third memory block BLK3, the q-th memory block BLKq, and the like) into the target memory block. The controller 1210 of FIG. 3 may effectively improve the spatial efficiency in the memory device 1220 by merging the memory blocks having the largest remaining space (i.e., the memory blocks classified into the first group G1) into the target memory block in preference to other memory blocks.

In some embodiments, the controller 1210 of FIG. 3 may merge at least one or more of the memory blocks classified into the second group (not shown) into the target memory block, according to an internal policy or based on a size of a remaining space in the target memory block, after merging the memory blocks classified into the first group G1 into the target memory block. Similarly, the controller 1210 of FIG. 3 may sequentially merge memory blocks classified into the third group (not shown) through the r-th group Gr into the target memory block.

FIG. 11 illustrates a merge operation of a storage device according to an embodiment of the present disclosure. Referring to FIG. 11, the memory device 1220 of FIG. 3 may include a plurality of super memory blocks SB1 to SBk each including a plurality of memory blocks. The plurality of super memory blocks SB1 to SBk may be allocated to zone regions, respectively.

The plurality of super memory blocks SB1 to SBk may each include a plurality of memory blocks, and may sequentially or randomly write data to be stored in a zone region into the plurality of memory blocks. For example, the first super memory block SB1 may include first to m-th memory blocks BLK11 to BLK1m. The first to m-th memory blocks BLK11 to BLK1m may store first to m-th valid data VD11 to VD1m of the first zone region Z1, respectively, and may have first to m-th remaining spaces RS11 to RS1m. A size of a remaining space in the first super memory block SB1 may be the sum of sizes of the first to m-th remaining spaces RS11 to RS1m. Similarly, a size of a remaining space in the second super memory block SB2 may be the sum of sizes of first to m-th remaining spaces RS21 to RS2m in first to m-th memory blocks BLK21 to BLK2m.

The controller 1210 of FIG. 3 may determine the first super memory block SB1 and the second super memory block SB2 as victim super memory blocks. In some embodiments, in response to determining that the size of the remaining space in the first super memory block SB1 (i.e., the sum of the sizes of the first to m-th remaining spaces RS11 to RS1m) and the size of the remaining space in the second super memory block SB2 (i.e., the sum of the sizes of the first to m-th remaining spaces RS21 to RS2m) respectively exceed a threshold size, the controller 1210 may determine the first super memory block SB1 and the second super memory block SB2 as the victim super memory blocks.

In some embodiments, in response to determining that the number of memory blocks, among the memory blocks BLK11 to BLK1m of the first super memory block SB1, with a remaining space exceeding the threshold size exceeds a reference value, the controller 1210 of FIG. 3 may determine the first super memory block SB1 as a victim super memory block. Similarly, in response to determining that the number of memory blocks, among the memory blocks BLK21 to BLK2m of the second super memory block SB2, with a remaining space exceeding the threshold size exceeds the reference value, the controller 1210 may determine the second super memory block SB2 as a victim super memory block.

The controller 1210 of FIG. 3 may determine the k-th super memory block SBk, among the plurality of super memory blocks of the memory device 1220, as a target super memory block. For example, the controller 1210 may determine, as the target super memory block, a super memory block that is either unallocated to any zone region or currently empty.

The controller 1210 of FIG. 3 may merge the victim super memory blocks into the target super memory block. For example, the controller 1210 may merge the victim super memory blocks into the target super memory block by copying or moving valid data from the first and second super memory blocks SB1 and SB2 into memory blocks (e.g., first to m-th memory blocks BLKk1 to BLKkm) of the target super memory block. The controller 1210 may update a mapping table after performing the merge operation.

In some embodiments, the controller 1210 may merge the memory blocks BLK11 to BLK1m and BLK21 to BLK2m of the first and second super memory blocks SB1 and SB2, which are the victim super memory blocks, into the memory blocks BLKk1 to BLKkm of the k-th super memory block SBk, which is the target super memory block, respectively. For example, the controller 1210 may merge the first memory blocks BLK11 and BLK21 of the first and second super memory blocks SB1 and SB2 into the first memory block BLKk1 of the k-th super memory block SBk, the second memory blocks BLK12 and BLK22 into the second memory block BLKk2, and the m-th memory blocks BLK1m and BLK2m into the m-th memory block BLKkm.

In some embodiments, the memory blocks BLK11 to BLK1m and BLK21 to BLK2m of the first and second super memory blocks SB1 and SB2 may have the remaining spaces RS11 to RS1m and RS21 to RS2m of different sizes S11 to S1m and S21 to S2m, respectively. Therefore, after the merge operation, the memory blocks BLKk1 to BLKkm of the k-th super memory block SBk may have remaining spaces of different sizes, respectively. After the merge operation, the controller 1210 may write dummy bits DB1 to DBm into the remaining spaces of the memory blocks BLKk1 to BLKkm, thereby reducing or exhausting the remaining spaces.

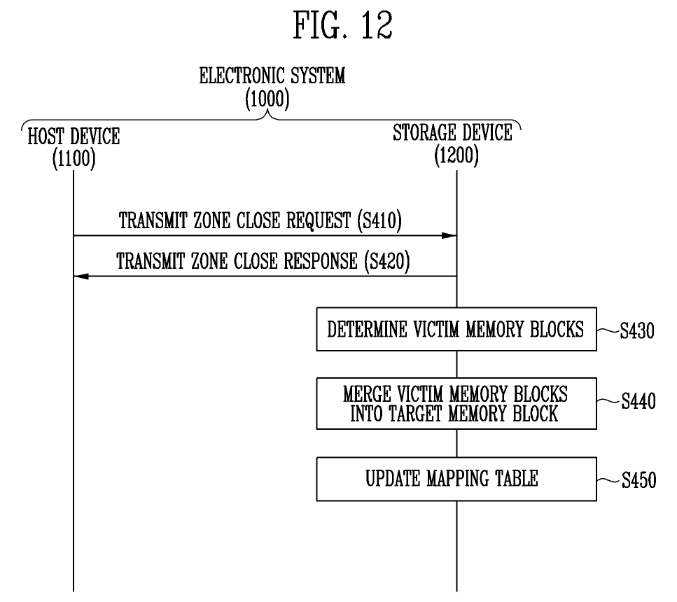

FIG. 12 illustrates a method of operating an electronic system 1000 according to some embodiments of the present disclosure. The electronic system 1000 may include a host device 1100 and a storage device 1200.

In step S410, the host device 1100 may transmit a zone close request to the storage device 1200. For example, the host device 1100 may determine one or more zone regions to be closed among a plurality of zone regions, and transmit the zone close request to the storage device 1200 to request closure of the determined zone regions.

In step S420, the storage device 1200 may transmit a zone close response to the host device 1100. For example, the storage device 1200 may close the zone regions determined to be closed in response to the zone close request received from the host device 1100, and transmit the zone close response indicating that the zone regions have been closed to the host device 1100.

In step S430, the storage device 1200 may determine victim memory blocks. For example, the storage device 1200 may determine, as victim memory blocks, one or more memory blocks allocated to the closed zone regions that have remaining spaces exceeding a threshold size. In some embodiments, the storage device 1200 may determine sizes of remaining spaces in the memory blocks allocated to the closed zone regions in response to the zone close request in step S420, and determine, as victim memory blocks, memory blocks having remaining spaces exceeding the threshold size.

In step S440, the storage device 1200 may merge the victim memory blocks into a target memory block. For example, the storage device 1200 may copy or move valid data from the victim memory blocks to a remaining space of the target memory block. In some embodiments, the storage device 1200 may write dummy bits into a remaining space of the target memory block after a merge operation.

In step S450, the storage device 1200 may update a mapping table. For example, the storage device 1200 may update the mapping table with information about the target memory block (or merged memory block), zone regions corresponding to the victim memory blocks, and offsets after merging the victim memory blocks into the target memory block. The mapping table may include information about a memory block in which valid data corresponding to each zone region is stored, as well as offsets in the memory block.

The storage device 1200 may merge the victim memory blocks into the target memory block and then update the mapping table accordingly, thereby managing the merged memory blocks that store the valid data of the closed zone regions. Upon receiving a read request from the host device 1100 for data in the closed zone regions, the storage device 1200 may refer to the mapping table and read the corresponding data from the target memory block.

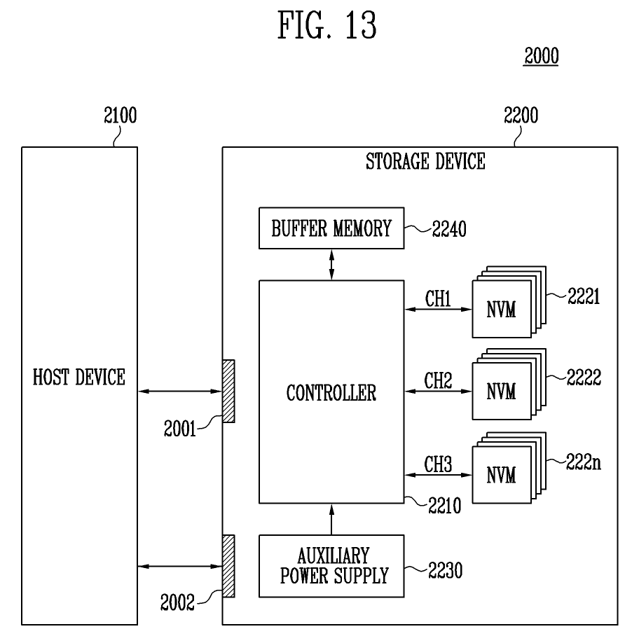

FIG. 13 illustrates an electronic system 2000 according to an embodiment of the present disclosure. Referring to FIG. 13, the electronic system 2000 may include a host device 2100 and a storage device 2200. The storage device 2200 may exchange signals with the host device 2100 through a signal connector 2001, and may receive power through a power connector 2002. The storage device 2200 may include a controller 2210, a plurality of non-volatile memory devices 2221 to 222n, an auxiliary power supply 2230, and buffer memory 2240.

According to an embodiment of the present disclosure, the controller 2210 may perform the functions of the controller 1210 of FIG. 3.

The controller 2210 may control the plurality of non-volatile memory devices 2221 to 222n in response to the signals received from the host device 2100. For example, the signals may be based on an interface of the host device 2100 and the storage device 2200. For example, the signals may be defined by at least one of communication standards or interfaces such as Universal Serial Bus (USB), MultiMedia card (MMC), embedded MMC (eMMC), peripheral component interconnect (PCI), PCI-express (PCI-e or PCIe), Advanced Technology Attachment (ATA), Serial-ATA, Parallel-ATA, small computer system interface (SCSI), enhanced small disk interface (ESDI), Integrated Drive Electronics (IDE), Firewire, Universal Flash Storage (UFS), Wi-Fi, Bluetooth, or NVMe interfaces.

The auxiliary power supply 2230 may be connected to the host device 2100 through the power connector 2002. The auxiliary power supply 2230 may receive a power voltage from the host device 2100 and may be charged. The auxiliary power supply 2230 may provide a power voltage of the storage device 2200 when the power supply from the host device 2100 is not smooth. For example, the auxiliary power supply 2230 may be located in the storage device 2200 or may be located outside the storage device 2200. For example, the auxiliary power supply 2230 may be located on a main board and may provide auxiliary power to the storage device 2200.

The buffer memory 2240 may operate as buffer memory of the storage device 2200. For example, the buffer memory 2240 may temporarily store data received from the host device 2100 or data received from the plurality of non-volatile memory devices 2221 to 222n, or may temporarily store metadata (e.g., a mapping table) of the plurality of non-volatile memory devices 2221 to 222n. The buffer memory 2240 may include volatile memory such as DRAM, SDRAM, DDR SDRAM, LPDDR SDRAM, or the like, or non-volatile memory such as FRAM, ReRAM, STT-MRAM, PRAM, or the like.

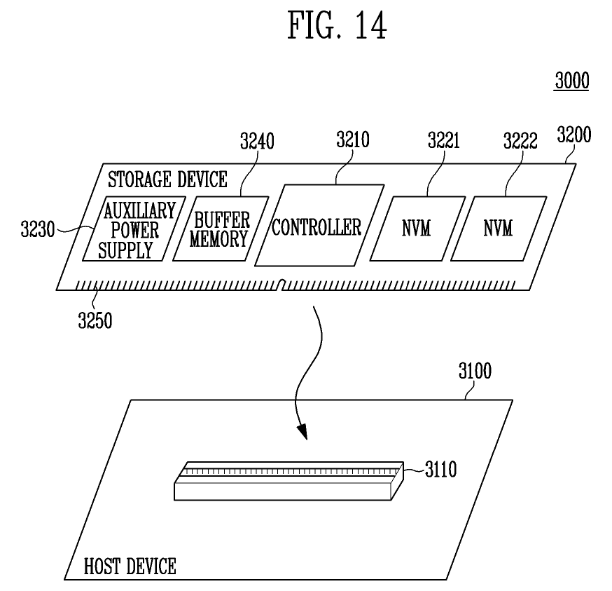

FIG. 14 illustrates an electronic system 3000 according to an embodiment of the present disclosure. Referring to FIG. 14, the electronic system 3000 may include a host device 3100 and a storage device 3200.

The host device 3100 may be configured in the form of a board such as a printed circuit board. Although not shown in FIG. 14, the host device 3100 may include background function blocks to perform the functions of the host device 3100.

The host device 3100 may include a connection terminal 3110 such as a socket, slot, or connector. The storage device 3200 may be mounted on the connection terminal 3110.

The storage device 3200 may be configured in the form of a substrate such as a printed circuit board. The storage device 3200 may be referred to as a memory module or a memory card. The storage device 3200 may include a controller 3210, a plurality of non-volatile memory devices 3221 and 3222, an auxiliary power supply 3230, buffer memory 3240, and a connection terminal 3250.

The controller 3210 may control various operations of the storage device 3200. According to an embodiment of the present disclosure, the controller 3210 may perform the functions of the controller 1210 of FIG. 3.

The plurality of non-volatile memory devices 3221 and 3222 may be used as storage media of the storage device 3200.

The auxiliary power supply 3230 may provide power input through the connection terminal 3250 to background functions of the storage device 3200. The auxiliary power supply 3230 may manage the power of the storage device 3200 based on the control of the controller 3210.

The buffer memory 3240 may temporarily store data to be stored in the plurality of non-volatile memory devices 3221 and 3222. Also, the buffer memory 3240 may temporarily store data read from the plurality of non-volatile memory devices 3221 and 3222. The data temporarily stored in the buffer memory 3240 may be transmitted to the host device 3100 or the plurality of non-volatile memory devices 3221 and 3222 based on the control of the controller 3210.

The connection terminal 3250 may be connected to the connection terminal 3110 of the host device 3100. Signals such as a command, addresses, or data, and power may be exchanged between the host device 3100 and the storage device 3200 via the connection terminal 3250. The connection terminal 3250 may be configured in various forms according to a manner of interfacing the host device 3100 and the storage device 3200. The connection terminal 3250 may be arranged on any side of the storage device 3200.

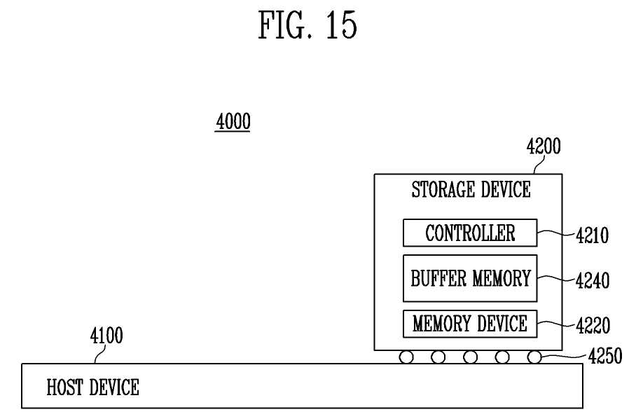

FIG. 15 illustrates an electronic system 4000 according to an embodiment of the present disclosure. Referring to FIG. 15, the electronic system 4000 may include a host device 4100 and a storage device 4200.

The host device 4100 may be configured in the form of a board such as a printed circuit board. Although not shown in FIG. 15, the host device 4100 may include background function blocks to perform the functions of the host device 4100.

The storage device 4200 may be configured in the form of a surface-mounted package. The storage device 4200 may be mounted on the host device 4100 through solder balls 4250. The storage device 4200 may include a controller 4210, a memory device 4220, and buffer memory 4240.

The controller 4210 may control various operations of the storage device 4200. According to an embodiment of the present disclosure, the controller 4210 may perform the functions of the controller 1210 of FIG. 3.

The buffer memory 4240 may temporarily store data to be stored in the memory device 4220. Also, the buffer memory 4240 may temporarily store data read from the memory device 4220. The data temporarily stored in the buffer memory 4240 may be transmitted to the host device 4100 or the memory device 4220 under the control of the controller 4210.

The memory device 4220 may be used as a storage medium of the storage device 4200.

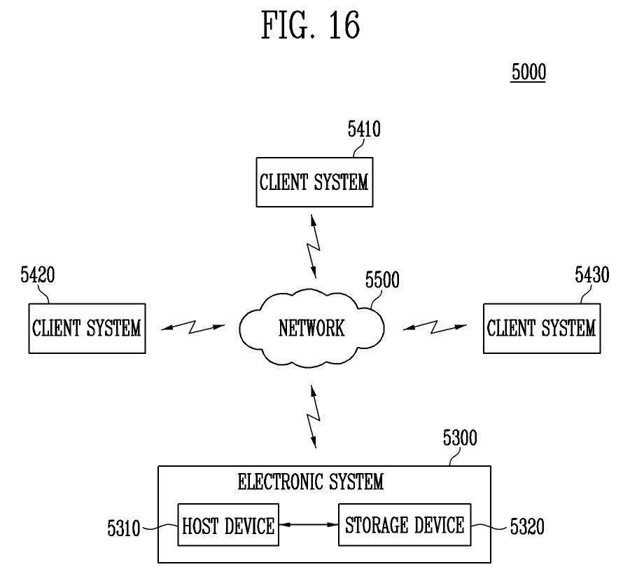

FIG. 16 illustrates a network system 5000 including an electronic system 5300 according to an embodiment of the present disclosure. Referring to FIG. 16, the network system 5000 may include the electronic system 5300 and a plurality of client systems 5410 to 5430 connected through a network 5500.

The electronic system 5300 may service data in response to requests from the plurality of client systems 5410 to 5430. For example, the electronic system 5300 may store data provided from the plurality of client systems 5410 to 5430. As another example, the electronic system 5300 may transmit data to the plurality of client systems 5410 to 5430.

The electronic system 5300 may include a host device 5310 and a storage device 5320. The host device 5310 may be configured similarly to the host device 1100 of FIG. 3, and the storage device 5320 may be configured similarly to the storage device 1200 of FIG. 3.

The foregoing are specific embodiments of the present disclosure. The present disclosure will include not only the embodiments described above, but also embodiments that can be simply redesigned or easily modified. The present disclosure will also include techniques that can be easily modified and implemented using embodiments. Therefore, the scope of the present disclosure should not be limited to the above-described embodiments, but should be defined by the appended claims as well as those equivalent to the claims of the present disclosure.

According to an embodiment of the present disclosure, a storage device that merges memory blocks, an operating method of the storage device, and an operating method of an electronic system including the storage device are provided.

In addition, a storage device capable of efficiently managing memory spaces by merging memory blocks with large remaining spaces, along with corresponding operating methods of the storage device and an electronic system including the storage device, are provided.

What is claimed is:

1. A storage device, comprising:
a memory device including a plurality of memory blocks; and
a controller configured to:
allocate one or more of the plurality of memory blocks to each of a plurality of zone regions;
determine, as victim memory blocks, one or more memory blocks having remaining spaces, sizes of which each exceed a threshold size, among memory blocks allocated to closed zone regions among the plurality of zone regions, a remaining space representing an empty space in which no data is stored; and
merge at least one or more of the victim memory blocks into a target memory block,
wherein the plurality of zone regions respectively correspond to logical address groups received from an external host device.

2. The storage device of claim 1, wherein the controller is configured to:
determine an empty K-th memory block among the plurality of memory blocks as the target memory block; and
control the memory device to copy valid data from the at least one or more of the victim memory blocks to the K-th memory block, and
wherein K is a positive integer.

3. The storage device of claim 1, wherein the controller is configured to:
determine a first memory block among the victim memory blocks as the target memory block; and
control the memory device to copy valid data from the at least one or more of the victim memory blocks to a remaining space of the first memory block.

4. The storage device of claim 3, wherein the remaining space of the first memory block is the largest among remaining spaces of the victim memory blocks.

5. The storage device of claim 1, wherein the controller is configured to:
determine, after merging the at least one or more of the victim memory blocks into the target memory block, whether a remaining space exists in the target memory block; and
in response to determining that the remaining space exists in the target memory block, control the memory device to write dummy bits into the remaining space of the target memory block.

6. The storage device of claim 1, wherein the controller is configured to merge, in response to determining that a number of the victim memory blocks exceeds a reference value, the at least one or more of the victim memory blocks into the target memory block.

7. The storage device of claim 1, wherein the controller is configured to merge the victim memory blocks into the target memory block in descending order of sizes of remaining spaces in the victim memory blocks.

8. The storage device of claim 1, wherein the controller classifies the victim memory blocks into a plurality of groups based on a comparison of sizes of remaining spaces in the victim memory blocks with a plurality of reference sizes, and
wherein the at least one or more of the victim memory blocks include victim memory blocks of a first group corresponding to a largest reference size among the plurality of groups.

9. The storage device of claim 1, wherein the controller includes a mapping table and is configured to update, after merging the at least one or more of the victim memory blocks into the target memory block, the mapping table with information indicating zone regions corresponding to the at least one or more of the victim memory blocks, the target memory block, and corresponding offsets.

10. The storage device of claim 1, wherein the plurality of memory blocks comprise a plurality of super memory blocks, each including two or more memory blocks,
wherein the victim memory blocks comprise victim super memory blocks, each including two or more victim memory blocks, and
wherein the target memory block comprises a target super memory block including a plurality of target memory blocks.

11. A method of operating a storage device, the method comprising:
allocating one or more of a plurality of memory blocks to each of a plurality of zone regions;
determining, as victim memory blocks, one or more memory blocks having remaining spaces, sizes of which each exceed a threshold size, among memory blocks allocated to closed zone regions among the plurality of zone regions, a remaining space representing an empty space in which no data is stored; and
merging at least one or more of the victim memory blocks into a target memory block,
wherein the plurality of zone regions respectively correspond to logical address groups received from an external host device.

12. The method of claim 11, wherein determining, as the victim memory blocks, the one or more memory blocks includes determining an empty K-th memory block among the plurality of memory blocks as the target memory block,
wherein merging the at least one or more of the victim memory blocks into the target memory block includes copying valid data from the at least one or more of the victim memory blocks to the K-th memory block, and
wherein K is a positive integer.

13. The method of claim 11, wherein determining, as the victim memory blocks, the one or more memory blocks includes determining a first memory block among the victim memory blocks as the target memory block,
wherein merging the at least one or more of the victim memory blocks into the target memory block includes copying valid data from the at least one or more of the victim memory blocks to a remaining space of the first memory block, and
wherein the remaining space of the first memory block is the largest among remaining spaces of the victim memory blocks.

14. The method of claim 11, further comprising:
determining, after merging the at least one or more of the victim memory blocks into the target memory block, whether a remaining space exists in the target memory block; and
in response to determining that the remaining space exists in the target memory block, write dummy bits into the remaining space of the target memory block.

15. The method of claim 11, wherein merging the at least one or more of the victim memory blocks into the target memory block comprises:
determining whether a number of the victim memory blocks exceeds a reference value; and
merging, in response to determining that the number of the victim memory blocks exceeds the reference value, the at least one or more of the victim memory blocks into the target memory block.

16. The method of claim 11, wherein merging the at least one or more of the victim memory blocks into the target memory block comprises:
classifying the victim memory blocks into a plurality of groups based on a comparison of sizes of remaining spaces in the victim memory blocks with a plurality of reference sizes; and
merging victim memory blocks of a first group, which corresponds to a largest reference size among the plurality of reference sizes, into the target memory block.

17. The method of claim 11, further comprising updating a mapping table, after merging the at least one or more of the victim memory blocks into the target memory block, with information indicating zone regions corresponding to the at least one or more of the victim memory blocks, the target memory block, and corresponding offsets,.

18. A method of operating an electronic system, the method comprising:
allocating, by a storage device, one or more of a plurality of memory blocks to each of a plurality of zone regions;
transmitting, by a host device, a zone close request to the storage device;
closing, by the storage device, zone regions indicated by the zone close request among the plurality of zone regions;
transmitting, by the storage device, a zone close response to the host device;
determining, by the storage device, as victim memory blocks, one or more memory blocks having remaining spaces, sizes of which each exceed a threshold size among memory blocks allocated to closed zone regions among the plurality of zone regions, a remaining space representing an empty space in which no data is stored; and
merging, by the storage device, at least one or more of the victim memory blocks into a target memory block,
wherein the plurality of zone regions respectively correspond to logical address groups received from the host device.

19. The method of claim 18, further comprising:
determining, by the storage device, whether a remaining space exists in the target memory block after merging the at least one or more of the victim memory blocks into the target memory block; and
writing, by the storage device, in response to determining that the remaining space exists in the target memory block, dummy bits into the remaining space of the target memory block.

20. The method of claim 18, wherein merging the at least one or more of the victim memory blocks into the target memory block comprises:
classifying, by the storage device, the victim memory blocks into a plurality of groups based on a comparison of sizes of remaining spaces in the victim memory blocks with a plurality of reference sizes; and
merging, by the storage device, victim memory blocks of a first group corresponding to a largest reference size among the plurality of reference sizes into the target memory block.
